(19) United States
(12) Patent Application Publication
(10) Pub. No.: US 2006/0243648 A1
(43) Pub. Date: Nov. 2, 2006

(54) Systems and Methods for Utilization of Waste Heat for Sludge Treatment and Energy Generation

(76) Inventors: Martin J. Shain, Seattle, WA (US); Rodger W. Phillips, Vashon, WA (US)

Correspondence Address: PRESTON GATES & ELLIS LLP, 1900 MAIN STREET, SUITE 600, IRVINE, CA, 92614-7319, US

(21) Appl. No.: 11/379,404

(22) Filed: Apr. 20, 2006

Related U.S. Application Data
(60) Provisional application No. 60/675,511, filed on Apr. 27, 2005.
(60) Provisional application No. 60/692,099, filed on Jun. 20, 2005.

(51) Int. Cl. C02F 1/02

(52) U.S. Cl. 210/175

(57) ABSTRACT

Disclosed systems and methods utilize waste heat from heat-producing facilities or processes to dry sludge. Disclosed systems and methods also utilize waste heat from heat-producing facilities or processes in the conversion of sludge into energy and energy products.

### CROSS REFERENCES TO RELATED APPLICATIONS

The present application claims the benefit, under 35 U.S.C. § 119, of U.S. Provisional Patent Application Ser. No. 60/675,511, filed Apr. 27, 2005, and U.S. Provisional Patent Application Ser. No. 60/692,099, filed Jun. 20, 2005, the contents of which are incorporated herein by reference.

### FIELD OF THE INVENTION

The present invention pertains to the utilization of waste heat from heat-producing processes to dry sludge. The present invention also pertains to the utilization of waste heat from heat-producing processes in the conversion of sludge into energy and energy products.

### BACKGROUND OF THE INVENTION

Historically, natural gas, geo-thermal, and nuclear power plants and other heat-producing facilities or processes (such as the production of paper or pulp) have struggled to dispose of waste heat generated by their production processes. For example, natural gas is typically combusted in large turbine engines to generate power. With even the most advanced heat re-capture technologies, only about 40-60% of the total energy contained in the natural gas is ultimately converted to electrical energy. The remainder is converted to excess heat which is typically captured in large quantities of process water. To avoid the build up of salts and other impurities in the process water, a large percentage of this water must be replaced on a daily basis creating significant disposal issues.

The negative environmental impacts of releasing large quantities of heated water into natural bodies of water are well known. The United States Environmental Protection Agency (EPA) and various other state environmental quality agencies have set limits on wastewater temperatures, requiring most large heat-producing facilities to build large pumping and cooling tower systems that are extremely expensive to operate. As a result, any reduction in the amount of water that must be cooled, or the overall amount of heat that must be disposed, is of great economic benefit to the facility.

Additionally, the disposal of organic sewage sludge poses a significant problem for most industrial and municipal wastewater facilities. Mechanical de-watering of sludge via common technologies such as filter presses, belt presses, and centrifuges, still produces a final product with greater than 70% water content. Facilities with the proper climate and adequate open space can spread de-watered sludge into thin layers to promote drying to a lower water percentage level over a several month period. Facilities with limited space or humid environments, however, are forced to dispose of sludge in its dewatered condition, or resort to extremely energy-intensive final drying techniques such as, without limitation, those employing direct and indirect drum dryers. The cost of final drying in these cases is typically prohibitive, forcing the disposal of de-watered sludge in landfills or on certain acceptable agricultural crops or grazing fields.

In recent years the disposal of de-watered sludge in the above described manners has proven ecologically sensitive. While short term disposal can have a positive effect on crop production, heavy metals and other contaminants in the material make long term disposal problematic, not to mention aesthetically disagreeable in certain areas.

For these above-described reasons, new technologies, such as Thermal Sludge Processing (TSP), have been developed to provide an alternative method to dispose of de-watered sludge. These processes utilize high heat and pressure to molecularly disassemble and reassemble organic materials found naturally in sewage sludge. The resulting product is an energy-rich synthetic fuel that can exist in either a liquid or gas state. This fuel can be further combusted to produce energy in a manner that eliminates and/or encapsulates the most harmful contaminants in the sludge.

One limiting factor of TSP technologies that remains is that the incoming sludge must have a low (for example, less than 10%) water content. Because most facilities cannot dry the incoming sludge to this level onsite, expensive and energy-inefficient equipment must be located alongside the TSP equipment to dry incoming de-watered sludge before it is thermally processed. The heat for final drying can come from many sources, including the thermal process itself. In that case, however, less fuel or gas is available to generate energy at the end of the process, reducing the overall efficiency of the system.

Based on the foregoing, there exists a need both for systems and methods to dispose of waste heat generated from heat-producing facilities or processes and to provide efficient, cost-effective and environmentally-sound systems and methods to dry sludge for TSP or disposal, as well as to convert sludge into an energy source or product. The presently described invention addresses these needs.

### BRIEF SUMMARY OF THE INVENTION

Disclosed herein are systems and methods for using waste heat from one or more heat-producing facilities to dry sludge and/or to generate energy from the sludge.

In one embodiment according to the present invention, the systems comprise a waste heat distribution module and one or more sludge processors. The waste heat distributor module can receive waste heat from a facility, including, without limitation, a plant, factory or mill, and can transfer the waste heat to the sludge processors.

In another embodiment of the systems according to the present invention, the sludge processors can include a sludge drying unit or a thermal sludge processor. In a particular embodiment of the systems according to the present invention, the sludge processors can include both a sludge drying unit and a thermal sludge processor.

In another embodiment of the systems according to the present invention, the thermal sludge processor can convert sludge to a fuel including a bio-oil, bio-gas, char or a combination thereof. In one particular embodiment of the systems according to the present invention, the bio-oil can be refined into an oil-derived product including diesel fuel, gasoline or heating oil. In another particular embodiment of the systems according to the present invention, the bio-gas can include methane, hydrogen, carbon dioxide and carbon monoxide.

In another embodiment of the systems according to the present invention, the systems further comprise an electric power generator configured to generate electricity from the fuel. In a particular embodiment of the systems according to the present invention, the systems transfer the electricity to an electrical grid.

In another embodiment of the systems according to the present invention, the systems further comprise an integrated control system for controlling the waste heat distribution module, the sludge processors and the electric power generator.

The present invention also comprises methods. In one embodiment according to the present invention, the methods comprise directing waste heat from a facility to a waste heat distribution module and distributing the directed waste heat to one or more sludge processors.

In another embodiment of the methods according to the present invention, the sludge processor is a sludge drying unit and the waste heat is used to dry sludge within the sludge drying unit. In another embodiment of the methods according to the present invention, the sludge processor is a thermal sludge processor and the waste heat is used to convert sludge within the thermal sludge processor into an energy source. In a particular embodiment of the methods according to the present invention, the sludge processor includes a sludge drying unit and a thermal sludge processor, and the waste heat is used to dry sludge within the sludge drying unit and/or to convert sludge within the thermal sludge processor into an energy source.

In another embodiment of the methods according to the present invention, the energy source is a fuel used to generate electric power. In a particular embodiment of the methods according to the present invention, the fuel includes a bio-oil, bio-gas, char or combinations thereof. In another particular embodiment of the methods according to the present invention, the bio-gas includes methane, hydrogen, carbon dioxide and/or carbon monoxide.

In another embodiment of the methods according to the present invention, the methods further comprise refining the bio-oil to produce an oil-derived product including diesel fuel, gasoline and/or heating oil.

In another embodiment of the methods according to the present invention, the electric power is distributed to an electrical grid.

The present invention also includes an energy source. In one embodiment according to the present invention, the energy source is produced by directing waste heat from a facility to a waste heat distribution module and distributing the directed waste heat to one or more sludge processors; wherein: (a) the sludge processor is a sludge drying unit and the waste heat is used to dry sludge within the sludge drying unit; (b) the sludge processor is a thermal sludge processor and the waste heat is used for converting sludge within the thermal sludge processor into an energy source; or (c) both (a) and (b).

In another embodiment of the energy sources according to the present invention, the energy source includes a bio-oil, bio-gas, char or combinations thereof.

The present invention also includes business methods. In one embodiment according to the present invention, the business methods comprise entering into an agreement based at least in part on one of more of the following activities: diverting waste heat from a facility; drying sludge with waste heat diverted from a facility; creating energy from sludge using waste heat diverted from a facility; creating electricity from sludge using waste heat diverted from a facility; and producing and/or selling a product made from sludge treated with waste heat diverted from a facility.

In another embodiment of the business methods according to the present invention, the product includes one or more of a bio-oil, bio-gas, char or combinations thereof.

### BRIEF DESCRIPTION OF THE DRAWINGS

FIG. 1 is a block diagram of a system for utilizing waste heat for drying sludge and/or generating fuel and/or energy in accordance with the present invention.

FIG. 2 is a flow chart illustrating a method for utilizing waste heat for drying sludge and/or generating fuel and/or energy in accordance with another aspect according to the present invention.

### DEFINITION OF TERMS

To aid in understanding the following detailed description according to the present invention, the terms and phrases used herein shall have the following, non-limiting, definitions.

As used herein, the term “facility” includes any place, industrial or otherwise, that produces excess heat in a sufficient amount to contribute to the drying of sludge. Facilities include but are not limited to plants, factories and mills.

As used herein, the term “sludge” includes any organic material that can be converted into an energy source at least in part or can be treated for disposal through the use of heat. In one embodiment, sludge includes sewage material from treatment plants, however the present invention is not so limited and can be used to treat any sort of organic material that can benefit in its conversion to energy, an energy source or energy product or in its disposal from the waste heat used in accordance with the present invention.

As used herein, the term “waste heat” includes heat generated from a process wherein the heat can be captured and directed.

### DETAILED DESCRIPTION OF THE INVENTION

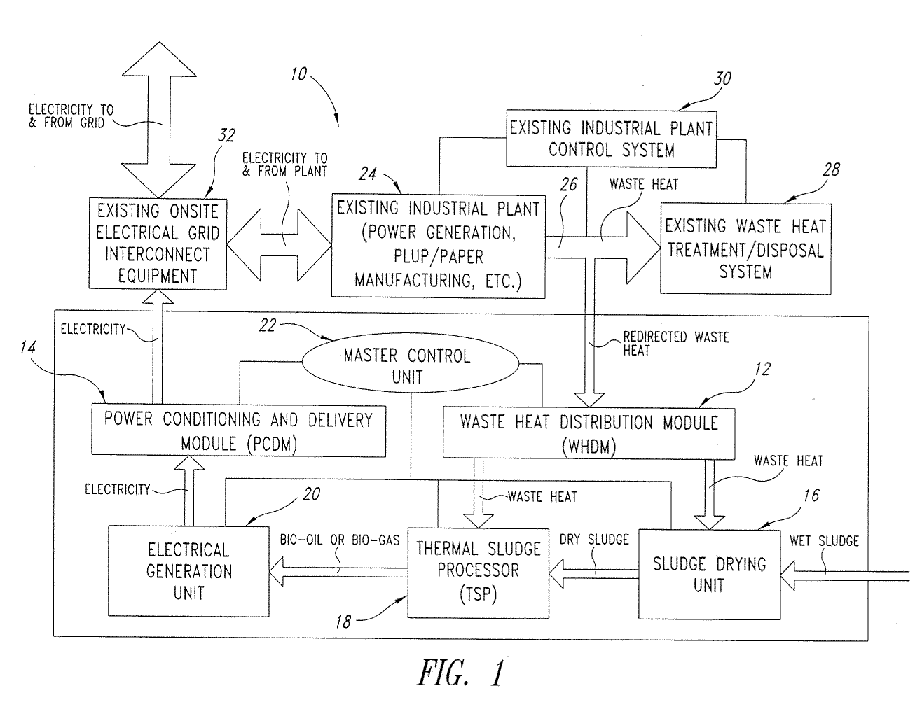

Many facilities generate waste heat that can be harmful to the environment if not properly treated before disposal. A number of processes requiring energy could benefit from the use of such waste heat. The disclosed embodiments according to the present invention provide a combination of systems and methods to efficiently dry sludge and/or to generate energy from sludge using waste heat. In one embodiment, as shown in FIG. 1, a system 10 or method for utilizing waste heat to dry sludge and generate energy includes a Waste Heat Distribution Module (WHDM) 12, a Power Conditioning and Delivery Module (PCDM) 14, a Sludge Drying Unit (SDU) 16, a Thermal Sludge Processor (TSP) 18 and an Electrical Generation Unit (EGU) 20. All of the above devices can be integrated via a Master Control Unit (MCU) 22 into a single process designed to safely dispose of waste heat and dry de-watered sludge while generating surplus energy.

In one embodiment according to the present invention, an existing facility 24 that generates waste heat can be modified to allow for the diversion of waste heat 26 to the SDU 16 and/or TSP 18 at a point prior to its entry into the facility's existing waste heat cooling system 28. These alterations can include, without limitation, the installation of diversion valves and piping that feed directly into the WHDM 12. In one embodiment, the WHDM 12 can be built as a unit that is separate from the existing facility 24 and can require no monitoring or control by facility staff. In another embodiment, the WHDM 12 can be located adjacent to the facility 24 to allow for easy conveyance of waste heat via the above mentioned systems.

In embodiments according to the present invention described thus far, no further changes to facility operations, personnel, or management practices other than the diversion of waste heat are required. It is to be understood, however, that the systems and methods according to the present invention can also be applied to the construction of an entirely new system instead of or in addition to the utilization of waste heat from an existing facility 24. In these embodiments, the new facility could be streamlined in several respects, including, without limitation, having a master control unit (MCU) 22 to control all units of the entire system.

In various embodiments according to the present invention, the WHDM 12 can contain, without limitation, ducts, valves, sensors and/or control logic (not shown) to convey an appropriate amount of waste heat to the SDU 16 and/or TSP unit 18. In particular, the WHDM 12 can direct waste heat into the SDU 16 at a proper rate to maintain desired temperatures and evaporative capacities. The SDU 16 can be of any suitable type, including but not limited to direct and indirect convective thermal dryers, contact surface dryer, spray dryers, fluid bed dryers, and various hybrid solar/convective type dryers.

As described earlier, dried sludge (dried by waste heat in accordance with the present invention or otherwise) can be fed into a TSP unit 18 where it can be converted under heat and pressure to an energy source. Non-limiting examples of such energy sources include fuel such as, without limitation, bio-oil, bio-gas, char, or combinations thereof. The WHDM 12 can also provide for the precise distribution of waste heat to portions of the TSP 18 to augment certain stages of the process. By augmenting heat from the TSP 18 process itself with waste heat from the WHDM 12, the TSP 18 can be optimized to produce an efficient amount of fuel for power generation purposes.

While the systems and methods according to the present invention focus on using waste heat to dry sludge and then, in certain embodiments, to convert the sludge into an energy source, in some embodiments, wet sludge can also be partially converted to an energy source, such as, without limitation, a bio-gas, before it is dried in the SDU 16. For example, wet sludge can be anaerobically digested to form a gas mixture of methane and carbon dioxide. The digested sludge can then be dried with SDU 16, and subsequently gasified to form a gaseous composition that includes carbon monoxide and hydrogen, as depicted in U.S. Pat. No. 6,410,283, which is expressly incorporated by reference herein. The gas mixture containing methane and carbon dioxide produced in the anaerobic digestion step can be mixed with the gas mixture containing hydrogen and carbon monoxide from the gasification step, and can be burned as a fuel for generating electricity. In the foregoing example, the WHDM 12 can convey the appropriate amount of waste heat to maintain desired temperatures of anaerobic bio-digesters further improving the efficiency of the process.

In one embodiment according to the systems and methods according to the present invention, a Power Conditioning and Delivery Module (PCDM) 14 can coordinate the conditioning, accounting, and delivery of electrical power generated through combustion of the fuel in the Electrical Generation Unit 20. The EGU 20 can include, but is not limited to, a steam generator, Stirling Engine, turbine, steam turbine, or traditional reciprocal engine. Any appropriate power generation technology that can utilize the fuel produced in the TSP is acceptable. It is important to note that the fuel itself can be the end product to be used either for onsite combustion and/or distribution. Additionally, fuel such as bio-oil can be further refined into other oil-derived products including, but not limited to, diesel, gasoline and/or heating oil.

Finally, in another embodiment according to the present invention, an integrated Master Control Unit (MCU) 22 can provide managers of the sludge drying process, sludge conversion process, or both with, for example and without limitation, real-time process monitoring, automated control logic and alarm/fault notification and recovery systems. This control module 22 can but need not be entirely separate from the pre-existing control system 30 that can be used by an existing facility 24 that provides waste heat (i.e., the power plant, pulp mill, etc.).

Thus, in operating the systems and methods depicted in FIG. 1, the existing facility 24 is modified to divert all or a portion of the waste heat 26 it produces to the waste heat distribution module 12. The waste heat is distributed by the WHDM 12 to the sludge drying unit 16 and/or the TSP 18. The sludge drying unit 16 receives wet sludge that is dried in whole or in part by utilizing the diverted waste heat distributed by the WHDM 12. The dried sludge can be processed at the TSP using additional waste heat provided by the WHDM 12 to form a fuel or reusable fuel, including, without limitation, bio-oil, bio-gas, char, or combinations of bio-oil, bio-gas and char. The fuel can then be consumed by an electric generator unit 20 to generate electricity. In one embodiment, the electricity can be conditioned and delivered to electrical grid interconnect equipment 32. From the interconnect equipment 32, the electricity can then be distributed to an electric grid. In addition, electricity generated from the existing facility, to the extent it is generated therein, can also be distributed to the electrical grid interconnect equipment 32. In another embodiment, the electricity (from the EGU 20, PCDM 14, electrical grid interconnect equipment 32, and/or existing industrial plant 24) can be stored, for example in one or more batteries, onsite and/or in a remote location, for later distribution. In one specific embodiment, the electricity can be stored in one or more batteries and then can be distributed to the electrical grid interconnect equipment 32 where it can be distributed to an electric grid.

Revenue from the systems and methods according to the present invention can come from multiple sources. First, the PCDM 14 and integrated control system 22 can precisely monitor the amount of electrical power (both kW and kWh) delivered to the interconnect equipment 32 for the general utility grid. The operators can be compensated for this power based upon negotiated rates paid by the electrical utility.

Second, because the facility 24 providing waste heat 26 would normally incur substantial expenses to eliminate this waste heat in an environmentally sound manner, the facility will compensate the operators of the present invention. In one embodiment this compensation can be based upon the value of avoided costs. This value can also be determined through negotiation and can be based upon the quantity of waste heat utilized by the sludge processing system.

Third, municipal and private wastewater facilities must dispose of partially dried biosolids and sludge. Current methods for doing so can be expensive, depending upon the distance the material must be hauled and the possibility of environmental contamination from other forms of disposal. Environmental concerns can be mitigated or eliminated via the sludge drying and processing systems and methods described herein, so it is expected that this process will provide a lower cost alternative for sludge disposal than other methods currently used. In one embodiment according to the present invention, specific rates to be charged per ton or per gallon for sludge disposal can be negotiated individually with wastewater facility operators.

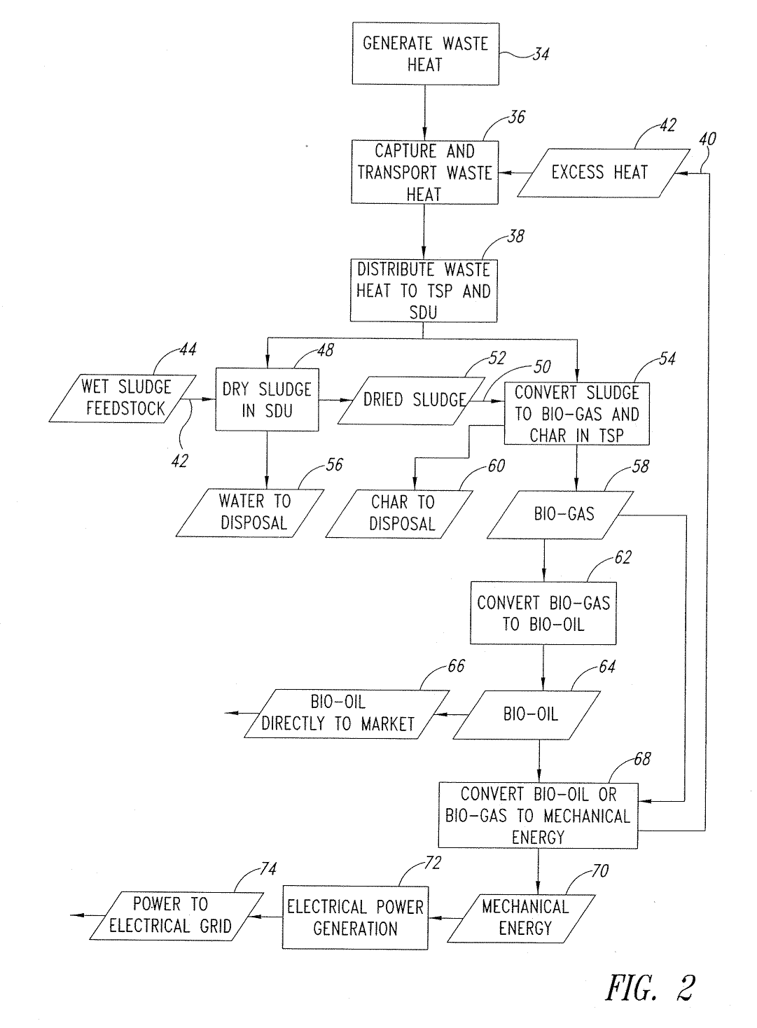

FIG. 2 illustrates one non-limiting method for utilizing waste heat for drying sludge and for processing sludge to produce fuel, which can be used to generate electricity or for other purposes in accordance with the present invention:

Step 1: Generate Waste Heat (34). Waste heat can be produced by a number of different facilities, including, without limitation, power generation (coal-fired, natural gas fired, nuclear, etc.), wood product processing (pulp & lumber mills) and various other heat-producing manufacturing processes. The methods according to the present invention can include constructing one or more such facilities or processes in order to create a readily available source of waste heat for the downstream sludge drying, processing, and power generation processes, can use one or more already-existing sources of waste heat or both.

Step 2: Capture and Transport Waste Heat (36). The systems and methods according to the present invention include an apparatus to collect heat from the waste heat source in the form of, without limitation, heated air, steam, liquid, or another useable form. This apparatus can consist of heat exchangers installed in the exhaust stream from the heat source, where heat can be captured prior to other forms of disposal. The apparatus can include all necessary valves, ducts, fans, pumps, and piping to redirect the heated material. In one embodiment this apparatus is the Waste Heat Distribution Module (WHDM; not shown). In another embodiment this apparatus collects and delivers heat to the WHDM.

Step 3: Distribute Waste Heat to TSP and SDU (38). The WHDM can control the delivery of waste heat to the downstream sludge drying and/or thermal processing stages using, in one embodiment, an automated control system. Using sensors located throughout one or more modules and processes, the WHDM can measure instantaneous heat requirements and can operate all necessary valves, ducts, piping, fans and pumps to deliver the required heat from the waste heat source. The WHDM can also coordinate the collection of excess heat from the thermal processing stage and can redirect this excess heat back into the overall process where required.

Step 4: Drv Sludge in SDU (48). In one embodiment, the primary consumer of waste heat delivered by the WHDM can be a Sludge Drying Unit (SDU) (not shown). This SDU can consist of an apparatus to convey wet sludge 44 (in certain embodiments about 70-80% moisture) from a storage facility or delivery vehicle into the sludge dryer at an appropriate rate. The sludge dryer can force the wet sludge through a process 48 whereby heat can be used to drive off excess moisture—in some embodiments leading to a final moisture content in the sludge of less than about 20%, less than about 15%, less than about 10%, or less than about 5%. In one embodiment, the sludge dryer can force the wet sludge through a process 48 whereby heat can be used to drive off excess moisture, leading to a final moisture content in the sludge of less than about 10%. The SDU can then convey (50) the dried sludge 52 directly to a thermal processing processor (TSP) (not shown) at the appropriate rate for further processing 54. Moisture laden hot air or steam from the SDU can be vented to the atmosphere where the moisture will quickly evaporate. In one embodiment, hot air from the SDU can be vented to the SDU for further sludge drying. In another embodiment, the exhaust air can be quenched and condensed to produce liquid water 56. In one specific embodiment, the liquid water 56 can be discharged into the local wastewater treatment system. In another specific embodiment, the liquid water 56 can be used for condensing hot air/steam, bio-gas or both, before it can be discharged into the local wastewater treatment system.

Step 5: Convert Sludge to Bio-Gas and Char in TSP. In the described embodiment, the TSP can use a high-pressure, high-temperature process 54 to convert incoming dried sludge 52 to a combination of, without limitation, bio-gas 58 and char. Char is a carbon-rich solid by-product of the conversion process 54 that is collected at the end of the process and can be disposed 60 in a number of environmentally beneficial ways. For example, bio-gas and/or char can be sold to commercial users or used for research purposes. The TSP process can be self sustaining, creating enough heat to maintain an ongoing reaction. However, energy from the WHDM can also be used to augment the creation of the high-temperature environment required for successful TSP reactions.

Step 6: Convert Bio-Gas to Bio-oil (62). The bio-gas from the TSP reaction may or may not be condensed into a liquid bio-oil 64 at this stage depending upon the method of mechanical energy conversion used in the next steps. Some devices require a liquid fuel (i.e., diesel engines) while others can be run directly on gas, or from heat generated by the combustion of either gas or oil. In some instances, the bio-oil can be of high enough quality to sell directly to outside markets (66), eliminating the need for mechanical energy conversion and electrical generation.

Step 7: Convert Bio-oil or Bio-gas to Mechanical Energy (68). In this step of the described embodiment, the energy-rich bio-oil or bio-gas can be combusted to produce heat or direct mechanical energy 70. Examples of this step can include, without limitation, using liquid bio-oil in place of diesel fuel to power a standard reciprocating engine—thus turning a drive shaft attached to the generator in the next step. Other systems can be configured to burn bio-gas in a boiler to create heat that can be converted to mechanical energy via a Stirling Engine or other form of “heat” engine. Still other configurations can involve the direct combustion of bio-gas in micro-turbines, again forcing the rotation of a drive shaft coupled to the Electrical Generation Unit (EGU). Yet still other configurations can involve directing and using hot air or steam from the SDU to augment the production of mechanical energy 70. In most cases, some amount of waste heat 42 can be created by this process. In one embodiment, this waste heat 42 can be collected and delivered (40) back into the WHDM for further use in the overall process.

Step 8: Electrical Power Generation (72). In this step of the described embodiment, the mechanical energy 70 generated through the combustion of bio-oil or bio-gas can be converted into electrical energy using common generator technologies. Electrical power can then be properly conditioned and delivered (74) onto a power grid by, for example, an integrated Power Conditioning and Delivery Module (PCDM).

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Certain embodiments of this invention are described herein, including the best mode known to the inventors for carrying out the invention. Of course, variations of these embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, references have been made to patents and/or printed publications throughout this specification. Each of the above cited references and printed publications are herein individually incorporated by reference in their entirety.

In closing, it is to be understood that the embodiments of the invention disclosed herein are illustrative of the principles according to the present invention. Other modifications that may be employed are within the scope of the invention. Thus, by way of example, but not of limitation, alternative configurations according to the present invention may be utilized in accordance with the teachings herein. Accordingly, the present invention is not limited to that precisely as shown and described.

1. A system comprising a waste heat distribution module and one or more sludge processors wherein said waste heat distribution module can receive waste heat from a facility and can transfer said waste heat to said one or more of said sludge processors wherein said one or more sludge processors participate in a process for converting sludge into a fuel, electric power or both.

2. A system according to claim 1, wherein said one or more sludge processors are selected from the group consisting of a sludge drying unit and a thermal sludge processor.

3. A system according to claim 1, wherein said one or more sludge processors comprise a sludge drying unit and a thermal sludge processor.

4. A system according to claim 3, wherein said sludge drying unit can dry said sludge and said thermal sludge processor can convert said sludge to said fuel.

5. A system according to claim 1, further comprising an electric power generator wherein said electric power generator is configured to generate electric power.

6. A system according to claim 1 wherein said system transfers said electric power to an electrical grid.

7. A system according to claim 5, further comprising an integrated control system for controlling said waste heat distribution module, said one or more sludge processors and said electric power generator.

8. (canceled)

9. (canceled)

10. A method comprising directing waste heat from a facility to a waste heat distribution module and distributing said directed waste heat to one or more sludge processors; wherein said one or more sludge processors participate in a process that converts sludge into a fuel, electric power or both.

11. A method according to claim 10, wherein said one or more sludge processors comprise a sludge drying unit and said waste heat is used to dry sludge within said sludge drying unit.

12. A method according to claim 10, wherein said fuel is selected from the group consisting of bio-oil, bio-gas, and char.

13. A method according to claim 10, wherein said fuel is used to generate electric power and wherein said electric power is distributed to an electrical grid.

14. (canceled)

15. A method according to claim 12, further comprising refining said bio-oil to produce an oil-derived product selected from the group consisting of diesel fuel, gasoline, and heating oil.

16. A method according to claim 12, wherein said bio-gas is selected from the group consisting of methane, hydrogen, carbon dioxide and carbon monoxide.

17. A fuel produced by a method according to claim 10.

18. (canceled)

19. A business method comprising entering into an agreement based at least in part on an activity comprising diverting waste heat from a facility to a sludge drying unit and/or a thermal sludge processor so that said waste heat participates in a process that converts sludge into a fuel, electric power, or both.

20. (canceled)

21. A system according to claim 5 wherein said electric power generator is configured to generate said electric power from said fuel.

22. A system according to claim 1 wherein said fuel is selected from the group consisting of bio-oil, bio-gas, and char.

23. A system according to claim 22 wherein said bio-oil is refined into an oil-derived product selected from the group consisting of diesel fuel, gasoline and heating oil.

24. A system according to claim 22 wherein said bio-gas is selected from the group consisting of methane, hydrogen, carbon dioxide and carbon monoxide.

25. A method according to claim 10, wherein said one or more sludge processors comprise a thermal sludge processor and said waste heat is used to convert sludge within said thermal sludge processor into said fuel.
